(19) United States
(12) Patent Application Publication
(10) Pub. No.: US 2004/0060069 A1
(43) Pub. Date: Mar. 25, 2004

(54) Testing and verification of cable modem systems

(75) Inventor: Howard Abramson, North Easton, MA (US)

Correspondence Address: Fogg and Associates, LLC, P.O. Box 581339, Minneapolis, MN, 55458-1339, US

(73) Assignee: ADC Broadband Access Systems, Inc.

(21) Appl. No.: 10/255,874

(22) Filed: Sep. 25, 2002

(51) Int. Cl. H04N 7/173; H04N 17/00; H04N 17/02

(52) U.S. Cl. 725/110; 725/111; 725/107; 348/192

(57) ABSTRACT

A method for testing a device of a cable modem system includes specifying a MAC address for the device under test, specifying one or more test messages for the devices under test, specifying a mode of failure for the messages, sending the messages to the device under test according to the failure mode and determining whether the device under test and other devices of the system respond correctly.

### TECHNICAL FIELD

The present invention is related in general to cable modem systems and devices and more particularly to a method and apparatus for testing of radio frequency interface components of cable modem systems.

### BACKGROUND INFORMATION

Cable operators today are rapidly deploying cable modem technology that enables subscribers to access the Internet over the same “wires” that deliver television signals, at speeds 100 times faster or more, than standard V.90 telephone modem technology, and without waiting for a dial-up connection.

In 1996, a number of cable operators commissioned the development of a specification for this emerging network known as the Data Over Cable Service Interface Specification (DOCSIS) with the objective of establishing a single specification for equipment to be connected to the network. DOCSIS (or its European counterpart, EuroDOCSIS) covers all operational elements used in delivering data service to end-users, including service provisioning, security, data interfaces and radio frequency interfaces (RFIs).

The architecture of the DOCSIS RFI consists of three major components: the cable modem termination system (CMTS), installed at the head end, or main facility, of the cable operator, the hybrid fiber coaxial (HFC) cable network wiring infrastructures (and any wireless links); and the customer cable modem, installed at the customer's premises. While this application refers to “cable” systems, it should be noted that the cable network “wiring” infrastructure referred to in this application may also include “air interface” wireless links such as microwave relay stations, and earth satellites in addition to the conventional hardwire and fiber optic links.

In order for cable operators to deploy two-way data services, they must upgrade their infrastructure from primarily a one way broadcast network to bi-directional communication capability. Cable operators are installing fiber optic cables from the head end to fiber distribution nodes to increase capacity. These nodes distribute the signals to 500 to 2000 homes, depending on configuration.

Cable modems (CMs) are also used at the head end to connect high-speed data pipes terminated in the cable operators facility to the HFC infrastructure. In general, the data connection is an IEEE 802.3 compliant 10 Mb or 100 Mbps Ethernet port on a router. The router can be connected to the Internet via a high-speed (T1 or faster) wide area network interface.

CMTSs translate data packets into radio frequency signals that are mapped into an unused 6 MHz television channel slot and broadcast to all homes by the HFC node. The signal is received in homes by cable modems on the local area network segment that are tuned to that channel slot. The cable modem downstream channel slot can be mapped anywhere in the downstream cable spectrum, from 50 MHz to 1 GHz or higher. Downstream throughput of the cable modem system (head end CMTS to subscriber modem) may be as high as 100 Mbps, depending on the quality of the HFC channel from the head end to the subscriber units.

The CMTSs of the cable operator's facility receive upstream signals from the cable modems on a different set of frequencies in the 0 to 45 MHz band. The throughput of this channel is variable, ranging in general, from 160 kbps to 10 Mbps, based on the quality and congestion of the upstream channel. The DOCSIS architecture provides for one downstream channel to send signals to all cable modems, which may, in turn, broadcast return signals on several different, nonoverlapping frequencies. A cable modem system under DOCSIS employs a continuous signal in the downstream direction and a time division multiple access (TDMA) burst signal in the upstream direction. Under DOCSIS the principal function of the cable modem system is to transmit Internet Protocol (IP) packets transparently between the head end (CMTS) and the subscriber location cable modems. In addition, certain management functions also ride on IP, including, for example, spectrum management functions and the downloading of software.

The cable modem translates the downstream radio frequency signal into packets, determines if the packets are destined for that particular cable modem and, if so, sends the packets along to the computer or a local area network on the client side of the cable modem. This network connection may be 10/100 Mbps Ethernet, universal serial bus (USB) or PCI, for example.

The original DOCSIS specification, conventionally known as DOCSIS 1.0, was designed simply for “best effort” service. It employed a request/grant mechanism for accessing upstream bandwidth and provided a single level of service for each modem. Upgraded versions of the specification have been developed to add additional features. In particular, DOCSIS 1.1 adds features and extensions designed to provide multiple levels or qualities of service (QoS) capabilities that enable the deployment of packet telephony, and other real-time applications and services.

As cable modem systems proliferate, improved evaluation and testing of network elements present increased challenges to ensure that reliable service is provided over systems and equipment involving many different manufacturers. Improved testing arises from the development of practical tests that cover a wide variety of possible failures, can be executed in a reasonable amount of time and allow operators to rapidly detect and resolve problems. However, developing a comprehensive and practical set of tests has proven to be a difficult challenge with so many variations in hardware and software, and the many possible modes of failure that may be encountered on a cable modem network. The present invention is designed to provide a framework for testing of CMTS and cable modem devices.

### BRIEF DESCRIPTION OF THE DRAWINGS

FIG. 1 is an illustration of one example of a system according to one embodiment of the present invention.

FIG. 2 is an illustration of one example of a messaging transaction between a cable modem and cable modem termination system.

FIG. 3 is an illustration of a “remote” state machine governing a messaging transaction between a cable modem and cable modem termination system.

FIG. 4 is an illustration of a “local” state machine governing a messaging transaction between a cable modem and cable modem termination system.

FIG. 5 is an illustration of one example of a messaging transaction between a cable modem and cable modem termination system in which a device has been programmed to “skip” a message, according to one embodiment of the present invention

FIG. 6 is an illustration of another example of a messaging transaction between a cable modem and cable modem termination system in which a device has been programmed to “skip” a message, according to one embodiment of the present invention

### DETAILED DESCRIPTION

In the following detailed description of the preferred embodiments, reference is made to the accompanying drawings that form a part hereof, and in which are shown by way of illustration specific embodiments in which the invention may be practiced. It is to be understood that other embodiments may be utilized and structural and/or design changes may be made without departing from the scope of the present invention.

In order to thoroughly test cable modem implementations and prove the correct operation of CMTS and cable modem devices it is useful to have one or more of the CMTS units or modems act in unpredictable ways to ensure that other devices respond appropriately in the presence of the failure. For example, with the dynamic servicing message protocol, there are seven state machines defined by DOCSIS. These state machines are mechanisms that assist in establishing voice calls and other applications where dynamic service levels are used, and define various service flow characteristics through the RFI. The state machines each have several different states and respond to and effect several different events. There are many, many permutations of the sequences of events, states and responses. Thus, in order to verify that system devices respond properly, tests must be carefully designed.

When normal tests are being run, and all devices are working correctly, in general, there is only one possible test path through the state machines. In a real network, however, the system does not always perform in an orderly way. Thus, it would be useful to be able to force or program error conditions to ensure that each transition through each state of one or more cable modems and CMTSs behaves correctly even when other systems and devices are malfunctioning.

Cable Laboratories is a research and development consortium of cable television system operators that performs various compliance and certification tests on cable related equipment. Cable Laboratories has defined a set of tests that are run every time a modem or CMTS device is submitted for qualification and Cable Laboratories has allowed manufacturers of CMTS devices and cable modems to include some testing functionality in hardware devices. Various manufacturers of CMTS devices and modems have included a predefined set of test information based upon acceptance of a test plan of procedures (ATP) written by Cable Laboratories. For example, to test the functionality of dynamic servicing messaging there are a limited number of predefined sets of information that are used in performing the tests. Unfortunately, the predefined sets of information are inadequate to cover all possible messaging failure scenarios and typically cover only a small subset of the programmable control tests that would be required for 100 percent path coverage, i.e., testing of every state, transition and event possible. For example, to perform 100 percent path coverage, device timers should be reprogrammable to values outside the parameters called for by the DOCSIS specification. Such programmability is not available. The present invention goes well beyond the predefined sets of information that are hard coded by cable modem and CMTS vendors in their devices and allows for arbitrary programming of information to be used in testing procedures. In addition, to ensure proper operation, the CMTS or cable modem should be able to arbitrarily respond to and/or generate expected or unexpected messages to determine how other devices of the system respond. Unfortunately, this capability is also missing or inadequate in existing cable modems and CMTS devices.

The present invention is designed to address the foregoing problems as well as other problems, at least in part, by including programmable capabilities in a CMTS device so that testing of one or more CMs and the CMTS can be accomplished effectively and easily. The present invention eliminates the need for modems that can be programmed to handle testing functions. Not only is testing made easier, but the present invention also enables testing that provides essentially full path coverage of the state machines running on the CMTS device and the cable modems of a cable modem system. In addition, while the present invention can be implemented in a cable modem or other device connected to a cable modem system, the present invention advantageously performs such tests from a CMTS at a central location and thus has the capability to test DOCSIS compliant cable modems regardless of their manufacture or whether the cable modems have ATP capabilities.

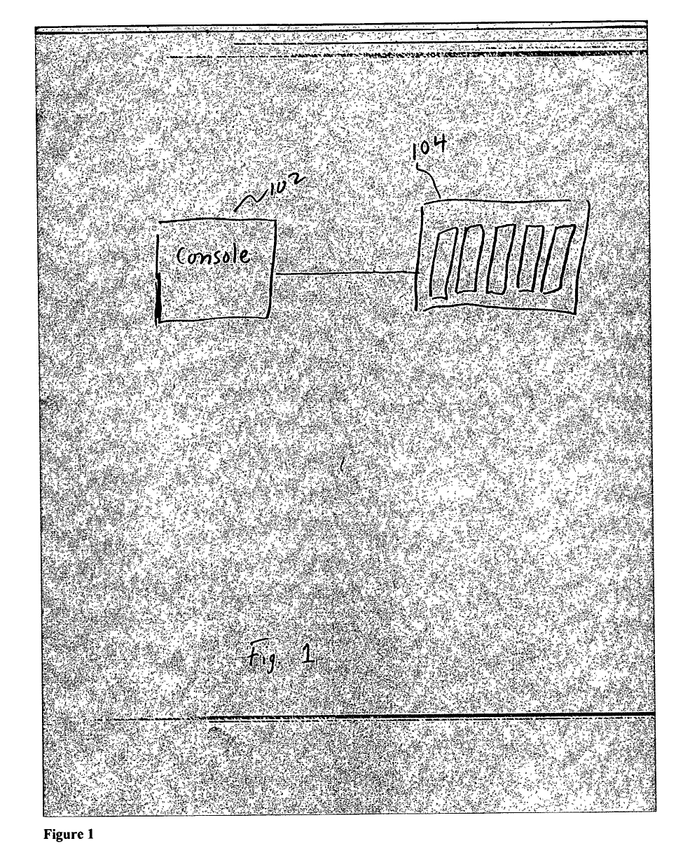

Referring to FIG. 1, one embodiment of the present invention includes a test console host 102 that is attached to a target CMTS chassis 104 via an interface such as a serial line or Ethernet link. The test console 102 may include a computer (PC) and one or more interface devices such as a switch or a hub for connecting the PC to the CMTS units of the CMTS chassis. The console 102 includes a host computer to run test and management software including one or more programs designed to test and validate devices and components of the cable modem system.

The system of the present invention generally includes an application that runs on a computer and which monitors, reads and writes CM and CMTS attributes and parameters. The present invention also generally includes an agent at the CMTS that receives messages and responds to them and a device that collects network objects or data variables that represent attributes of the managed agent. A management information base (MIB) may also be included to support the commands and parameters of the present invention.

In one embodiment, the present invention may be implemented under VxWorks®, a run-time component in the Tornado® embedded development platform. The present invention may also be implemented in another real-time operating system development platform (RTOS).

In general, the test process may be driven by operator commands entered at the VxWorks shell command prompt on test console 102. The operator may specify the CMTS card and chassis to access by a telnet or other communication protocol or interface. After communication with the CMTS agent has been established, the operator may enter one or more test commands at the command prompt of console 102. The agent then provides responses that are displayed and/or recorded. A series of tests may be executed by preparing a script. In addition, one or more tests may be completely automated so that operator intervention is not required.

The test commands are designed to cover virtually all possible messaging failure modes. For example, one such test involves a “skip” message command that can be set to skip various expected messages to the CMTS an arbitrary number of times. Thus, the cable modem system can programmed to operate in a normal way except that certain designated messages will be incorrect or will be skipped. The test consol 102 can monitor and evaluate whether one or more devices of the cable modem system are operating properly according to DOCSIS in response to the test.

The present invention further includes the capability to arbitrarily ignore messages that are received by the CMTS while the devices are online. A CMTS device according to the present invention may also arbitrarily refrain from sending messages to the modems or fail to acknowledge messages. For example, a CMTS device may be programmed to perform a test or procedure that will determine whether the CMTS device will ignore a message or fail to send a message to the modem.

Another capability of a CMTS device according to the present invention permits setting one or more event timer of a CM or CMTS to a value other than the value called for by the DOCSIS specification, as well as to reset timers to the values defined by the DOCSIS specification. Such capability permits negative testing of the modems as well as negative testing of the CMTS. In other words, in addition to performing “positive testing” to determine what the devices should be doing in response to various expected circumstances, the present invention performs “negative testing” of the response of the CMTS and modem devices in response to unexpected events to ensure that the devices respond properly. The present invention also may be used to perform stress testing on the CMTS and modem devices, if desired.

One example of the present invention, as noted above, involves testing of Dynamic Service messaging of the cable modem system. In the DOCSIS specification, various Service Flows may be created, changed or deleted. This is accomplished through a series of media access control layer (MAC) management messages referred to as Dynamic Service Messages. Such messages may include Dynamic Service Addition (DSA), Dynamic Service Change (DSC) and Dynamic Service Deletion (DSD). The DSA messages create a new Service Flow. The DSC messages change an existing Service Flow. The DSD messages delete a single existing upstream and/or a single existing downstream Service Flow. The Null state implies that no Service Flow exists that matches the service flow ID (SFID) and/or TransactionID in a message.

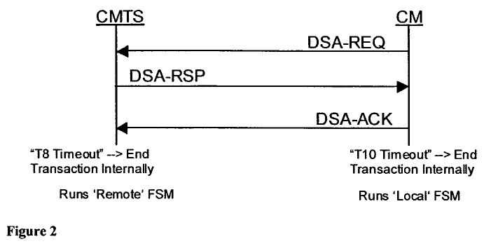

A simple example of the operation the present invention will now be discussed with reference to Dynamic Service messaging. As noted, each dynamic service message sequence is a unique transaction with an associated unique transaction identifier (SFID). The DSA/DSC transactions consist of a request/response/acknowledge sequence. A typical DSA/DSC sequence is shown in FIG. 2. In FIG. 2, a CM provides a DSA transaction request to a CMTS. When the system is operating as it should, i.e., according to the logic specified by the DOCSIS Radio Frequency Interface (RFI) specification for DSA, a DSA Request transaction that is initiated by a CM, to a CMTS, is followed by a DSA response from the CMTS (DSA-RSP) followed by an acknowledgement (ACK) of the response from the CM.

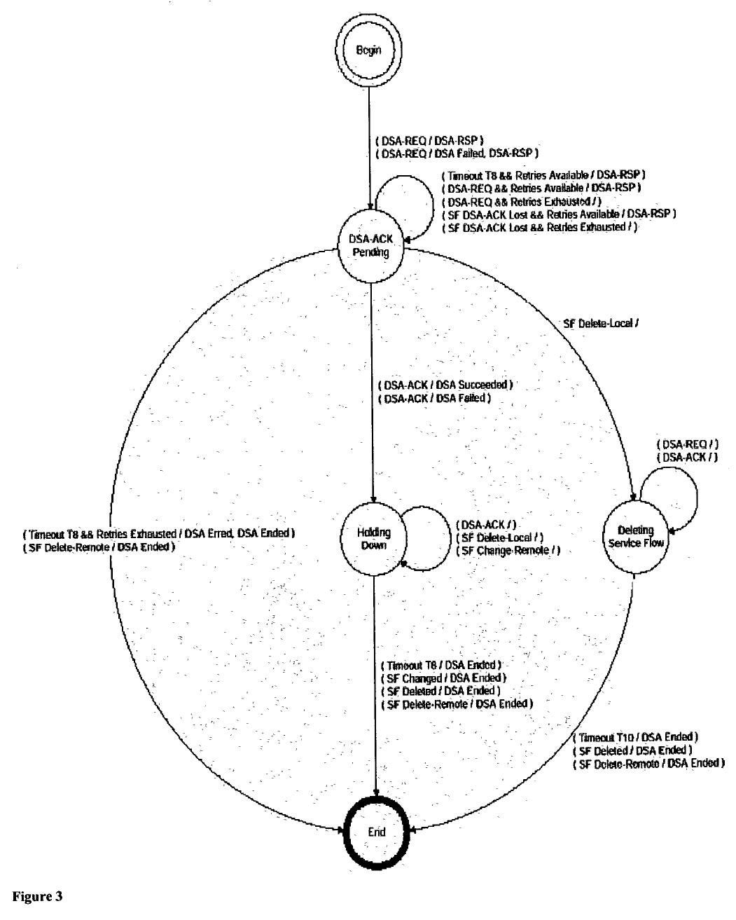

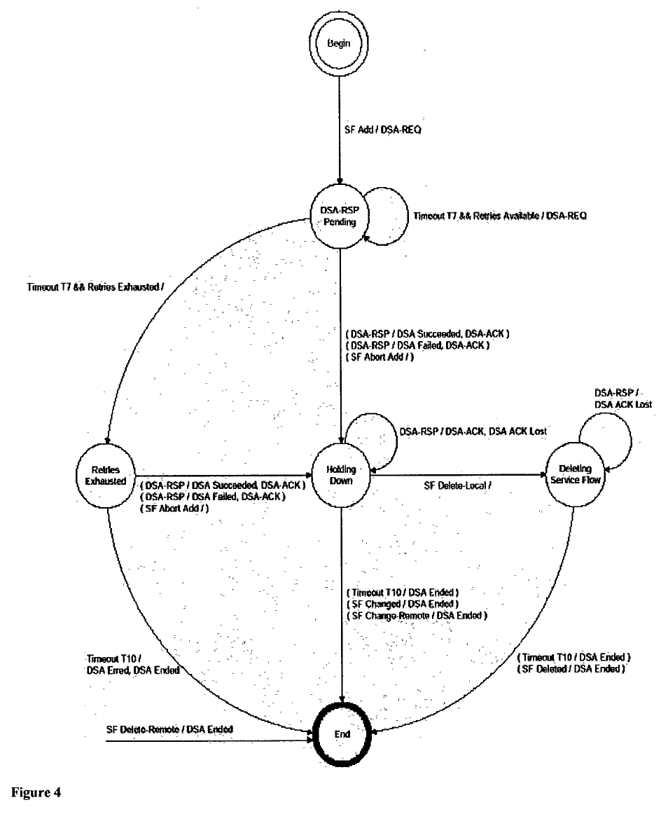

The transaction shown in FIG. 2 is typically used to establish service flows between the CM and CMTS (i.e., to guarantee bandwidth and timing for a Voice Over Internet Protocol telephone call). The CM's request is responded to by the CMTS, which then waits for an acknowledgment from the CM. Loss or delay of any of these messages or the receipt of an unexpected message during this exchange must follow specific rules that are defined by Finite State Machines (FSMs) from the DOCSIS RFI. Two of the FSMs from the RFI, the “remote” and “local” initiated FSMs, are shown in FIGS. 3 and 4, respectively. A detailed explanation of these state machines is provided in the DOCSIS RFI and will not be repeated here. In general, however, the FSMs define timeout periods within which service flow transactions must take place. In the example of FIG. 2, a CM initiated DSA request, the ‘Remote’ FSM runs on the CMTS and the ‘Local’ FSM runs on the CM.

The three messages of FIG. 2 followed by T8 and T10 timeouts, shown above, describe a ‘straight line’ transition through the states specified on the remote and local FSMs, FIGS. 3 and 4, respectively. In other words, when the system is operating normally, the state machines will transition along straight lines shown in the state machine diagrams of FIGS. 3 and 4.

The loss of messages or receipts of unexpected messages follow the ‘curved’ lined transitions between the FSM states shown in FIGS. 3 and 4. These ‘error’ cases are required to maintain consistency between the CMTS and CM. Detection of a lost or delayed message is provided by the expiration of various timers that are started by each device, e.g., T7, T8, and T10. In the transaction shown in FIG. 2, the loss of a DSA-ACK from the CM to the CMTS will be detected by the expiration of the T8 timer on the CMTS. Similarly, loss of a DSA-RSP from the CMTS to the CM will be detected by the expiration of the T7 timer on the CM.

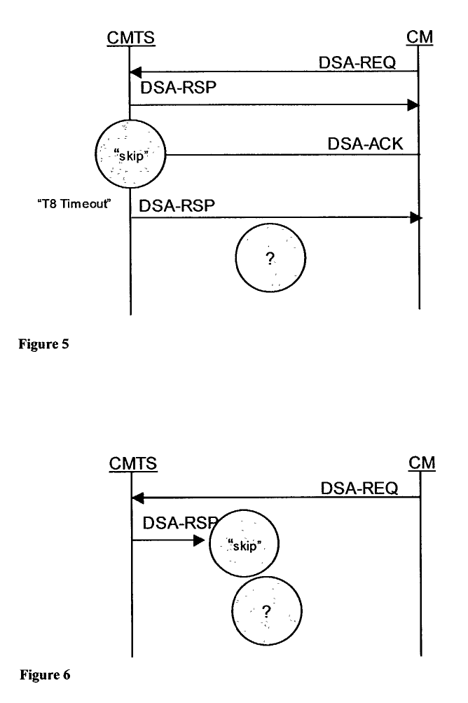

FIG. 5 shows a sequence of events according to the present invention in which the remote (i.e., the CMTS) device is ‘programmed’ to skip an ACKnowledgment after sending a ReSPonse message. The CMTS will time out after time period T8 and send another ReSPonse message to the CM. Understanding what happens after the ACK is ‘skipped’ is extremely useful in verifying correct behavior of the CM and CMTS. The only other way to test this condition would be to place the ‘skip’ functionality in the CM or to temporarily remove the CM or CMTS from the HFC network. Unfortunately, removing a device from the HFC network at ‘just the right’ time is a very difficult task and usually results in invalidating the test. Not having a CM that can skip this message requires that the CMTS skips the message without affecting its normal operation.

FIG. 6 illustrates an error condition in which the CMTS is programmed to skip sending a ReSPonse message in response to a CM request. In this example, the present invention will determine whether the CM responds appropriately when the CM does not receive the ReSPonse from the CMTS and will also determine whether the CMTS responds appropriately to a response or a failure of the CM. Understanding what the CM and CMTS do in this case provides valuable information to verify correct operation of both devices. Again, without device failure programmability or ‘very fast hands’ (to temporarily remove the device from the HFC network), this test is impossible.

While the foregoing examples illustrate tests involving DSA messaging, other CM-CMTS messaging transactions may likewise be tested with the system of the present invention. For example, DSD transactions consist of a request/response sequence. The response messages should contain a confirmation or acknowledgement code of “okay” unless some exception condition was detected. The acknowledge messages should include the confirmation code in the response unless a new exception condition arises. Once the Service Flow exists, it is operational and has an assigned SFID. In steady state operation, a Service Flow resides in a Nominal state. When Dynamic Service messaging is occurring, the Service Flow may transition through other states, but remains operational. Since multiple Service Flows may exist, there may be multiple state machines active, one for every Service Flow. Dynamic Service messages only affect those state machines that match the SFID and/or Transaction ID. Similarly, CM registration messaging, bandwidth requests and a variety of other DOCSIS MAC-specific messages may also be tested.

Detailed examples of additional tests that may be performed in one or more embodiments of the present invention are as follows. These examples are not exhaustive of the tests performed by the present invention and are meant to be illustrative only.

MAC-06

This test provides for testing of one or more cable modems by setting the number of times of a ranging request for one or more modems to any value including zero. Thus, if an incoming ranging request is skipped then a modem should attempt to reconnect. If it fails to attempt to reconnect, then the test fails.

BW-REQ

BW-REQ tests how a CM deals with a loss of bandwidth request. This is how the modem requests access to send data upstream. Thus, the CMTS may ignore the modem's request for upstream bandwidth. The modem should respond by attempting again to obtain bandwidth as specified in DOCSIS.

INIT-REG

Registration requests or registration acknowledgements can also be skipped. Again, the modem needs to respond as specified in DOCSIS. There are two timers associated with registration, T6 and T9. The invention has the ability to change those timers to arbitrary values to determine if the modem responds as specified. The CMTS is also tested in the process. For example, if the CMTS registration acknowledgement is skipped, and not received within what is normally the T6 time, the CMTS should re-send the response. In this way the modem and CMTS can be tested to see how the system deals with multiple events.

SF-02-DSX

As noted, acceptance test plans (ATPs) defined by Cable Labs for certifying modems and qualifying CMTSs include limited testing of dynamic service messaging. The three messages for dynamic service, DSA, DSC and DSD, can originate from a modem or the CMTS. A CMTS (or other device) according to the present invention can be programmed to provide certain erroneous responses to DSA, DSC or DSD (“DSX”) messages to negative test the modem. For example, the CMTS can be programmed to skip messages in either direction, i.e., messages originating from the modem or CMTS. In addition, timers can be reprogrammed to values outside the DOCSIS specification to test cable modem or CMTS responses. Additional detail concerning programming of DSX tests according to the present invention is provided below.

SF-02 Test 3a: CM DSA-RSP & DSD-REQ Max Retries

Set the CM Mac Address Under Test (or leave blank to skip all)

Set the SkipCmtsRsp

# SetSkipCmtsRsp(4)

Define a DSA-REQ

# SetDsaRequest(“. . .”) or use pre-defined value

use ShowDsaRequest( ) to see existing value

Initiate a DSA-REQ from the CM

SF-02 Test 3c: CM DSA-REQ Max Retries

Set the CM Mac Address Under Test (or leave blank to skip all)

Set the SkipCmReq

# SetSkipCmReq(4)

Set the CM Accepted Request so that all requests are skipped

# SetAcceptedCmReq(1)

Initiate a DSA-REQ from the CM

Cable Modem Under Test

The present invention also includes the ability to program test functions for one modem or all modems. Individual modems may be specified by their own unique Media Access Control (MAC) address. A MAC address is a hardware address that uniquely identifies each node of a network. Most of the programmable functionality of the present invention is keyed off of the MAC Address of one or more CM, CMTS or other devices under test. That is, skipping specific MAC Management Messages may be defined for all CMs or for a specific CM. Similarly, addition or change of flows may be defined for a specific CM. For example, the following API permits testing of a single CM.

SetCmMacAddrUnderTest(macAddress)

Usage:

SetCmMacAddrUnderTest(<“mac address”>)

where,

mac address—ASCII representation of HEXadecimal Mac Address, e.g., “00:00:00:00:00:01”

The MAC Address of the CM under test may be displayed by issuing the following command from the shell.

# ShowCmMacAddrUnderTest

CMTS Initiated DSX

CMTS initiated DSA, DSC and DSD messages (collectively referred to as DSX messages) are based on the definition of byte encoded type linked value (TLV) request strings. TLVs allow for encoding of information about service flow. These messages specify how fast and how much data is permitted to or from the modem. For example, DSA-REQ, DSC-REQ and DSD-REQ messages are defined at the CMTS for transmission to specific modems. These request parameters may be defined via the following commands:

SetDsaRequest(TLVs)

SetDscRequest(TLVs)

SetDsdRequest(TLVs)

where, TLVs is a HEXadecimal representation of the DOCSIS 1.1 defined TLVs for Upstream and Downstream Flows (Types 24 and 25), Upstream and Downstream Classifiers (Types 22 and 23), and PHS Rules (Type 26). Examples of setting DSA or DSC REQuest values are as follows:

SetDsaRequest(“18:33:03:02:00:03:18:04:00:00:00:01:01:02:00:01:02:04:00:00:00:03:0F:01:06:06:01:06:16:01:01:13:02:00:64:14:04:00:00:27:10:15:04:00:00:07:D0:10:04:00:00:01:FF:16:1E:01:01:01:02:02:00:03:04:04:00:00:00:03:03:02:00:01:05:01:40:09:08:07:02:00:0A:08:02:00:0A:19:16:01:02:00:02:02:04:00:00:00:04:06:01:06:08:04:00:3D:09:00:07:01:07:17:1E:01:01:02:02:02:00:04:04:04:00:00:00:04:03:02:00:02:05:01:40:09:08:07:02:00:0C:08:02:00:0C:”)

SetDscRequest(“18:29:01:02:00:01:02:04:00:00:00:08:0F:01:06:06:01:06:16:01:01:13:02:00:C8:14:04:00:00:27:10:15:04:00:00:07:D0:10:04:00:00:01:FF:16:21:01:01:01:02:02:80:01:03:02:00:01:04:04:00:00:00:08:05:01:40:07:01:01:09:08:07:02:00:0A:08:02:00:A:19:16:01:02:00:02:02:04:00:00:00:09:06:01:06:08:04:00:3D:09:00:07:01:07:17:21:01:01:02:02:02:00:01:03:02:00:02:04:04:00:00:00:09:05:01:40:07:01:01:09:08:07:02:00:0D:08:02:00:0D:”)

SetDsdRequest(“18:06:02:04:00:00:00:03:19:06:02:04:00:00:00:04:”)

Setting the DSD REQuest values should only include Types 24 and 25 and sub-type 2 for the SFID(s) to delete. TLVs should be defined to be valid parameters for Service Flows, Classifiers, and PHS Rules (CMTS does not presently support PHS). Upstream parameter applicability may be found in Table 8-4 of the DOCSIS 1.1 RFI and the definition of applicable upstream and downstream TLVs in Appendix C of the RFI. An understanding of which parameters are required is necessary to create other DSX TLV messages.

The following commands display the current values of each DSX-REQuest string.

ShowDsaRequest( )

ShowDscRequest( )

ShowDsdRequest( )

ShowAllDsxReqTlvs( )

The following commands provide additional ease of use for the above commands:

SetDsdRequest(usSfld, dsSfld)—build the DSD-REQuest string using the upstream and downstream values provided (use a zero for the upstream value to set a string for a downstream SFID only).

SetAtpDsaRequest(“TLVName”)

SetAtpDscRequest(“TLVName”)

where, TLVName is one of the following pre-defined names that corresponds to the TLVs defined in SF-02 of the ATP:

DsaUsf100a

DsaUsf100aDsfc

DsaUsf100abcDsfc

DsaUsf300a

DscUsf200a

DscUsf200aDsfd

DscUsf200abcDsfd

DscUsf200zDsfd

DscUsf300a

Transmitting DSX REQuests

The following functions are defined to permit the simple transmission of predefined DSX-REQuest TLVs to a specified CM. The transmission of the DSX messages does NOT initiate a Dynamic Service Flow state machine on the CMTS but will result in initiation of a DSX FSM on the CM (e.g., the message is simply transmitted to the CM in question).

TransmitDsaRequest([“macAddress”])

TransmitDscRequest([“macAddress”])

TransmitDsdRequest([“macAddress”])

where, macAddress is the ASCII representation of the HEXadecimal Mac Address of the CM, e.g., 00:00:00:00:00:01. If the macAddress is not included, the CM Under Test should be set for a message to be sent.

Adding Flows

The following command should be used to start a CMTS Initiated DSA Dynamic Service Flow state machine.

AddLocalFlows([“macAddress”])

where,

“macAddress” is the ASCII representation of the HEXadecimal Mac Address of the CM, e.g., “00:00:00:00:00:01”. If the macAddress is not included, the CM Under Test should be set for a message to be sent.

The pre-defined DSA-REQuest TLVs will be sent to the CM specified in the command or the CM under test and flows will be added as defined by the RFI.

Changing Flows

The following command may be used to start a CMTS Initiated DSC Dynamic Service Flow state machine.

ChangeLocalFlows(usSfld, dsSfld, [“macAddress”])

where, macAddress is the ASCII representation of the HEXadecimal Mac Address of the CM, e.g., “00:00:00:00:00:01”. If the macAddress is not included, the CM Under Test should be set for a message to be sent.

usSfld is the SFID of the Upstream Flow to change (zero if downstream only).

dsSfld is the SFID of the Downstream Flow to change (zero if upstream only).

The pre-defined DSC-REQuest TLVs will be sent to the CM specified in the command or the CM under test and flows will be changed as defined by the RFI.

Deleting Flows

The following command may be used to start a CMTS Initiated DSD Dynamic Service Flow state machine.

deleteLocalFlows(usSfld, dsSfld, [“macAddress”])

where, macAddress is the ASCII representation of the HEXadecimal Mac Address of the CM, e.g., “00:00:00:00:00:01”. If the macAddress is not included, the CM Under Test should be set for a message to be sent.

usSffd is the SFID of the Upstream Flow to delete (zero if downstream only).

dsSfld is the SFID of the Downstream Flow to delete (zero if upstream only).

A DSD-REQuest will be created and sent to the specified CM or CM under test and delete the flow(s) as defined by the DOCSIS RFI.

Message Processing Actions

SetSkipCmReq(val)

sets the, val, number of CM Requests to ignore once the first request is processed. That is, once the first request is accepted, to start the DSX FSM or REG process, it is to ignore subsequent CM Requests (up to this number of times)

SetSkipCmRsp(val)

sets the, val, number of CM Responses to ignore

SetSkipCmAck(val)

sets the, val, number of CM Acknowledgments to ignore

SetSkipCmtsReq(val)

sets the, val, number of CMTS Requests to NOT transmit once the first request is sent. That is, once the first request is transmitted, to start the FSM, it is to ignore subsequent request transmissions (up to val times)

SetSkipCmtsRsp(val)

sets the, val, number of CMTS Responses to NOT transmit

SetSkipCmtsAck(val)

sets the, val, the number of CMTS Acknowledgments to not transmit.

It should be noted that if the m_CmMacAddrUnderTest is all zeros and the message to skip is set, then the message is skipped for all CMs. Similarly, if the m_CmMacAddrUnderTest is all zeros and a programmable response is set, that response will be sent to any CM.

Additional commands may be included to force the CMTS to skip the first CM REQuest or not transmit the first CMTS initiated request. Examples are as follows:

SetAcceptedCmReq(val)

When val is set to 1 it is used to force the first REQuest to be ignored. When cleared to zero, the first request is accepted.

SetAcceptedCmtsReq(val)

When val is set to 1 it is used to force the first REQuest to not be transmitted. When cleared to zero, the first request is transmitted.

Additional commands may be included to provide the state of each of the previous parameters:

ShowAllProgParms( )—short cut to show all of the following

ShowSkipCmReq( )

ShowSkipCmRsp( )

ShowSkipCmAck( )

ShowSkipCmtsReq( )

ShowSkipCmtsRsp( )

ShowSkipCmtsAck( )

ShowAcceptedCmReq( )

ShowAcceptedCmtsReq( )

ShowSendDsxWithNoFsm( )

ShowDsxProgRsp(void)

Programmable Timers

The following commands may be included in one example of the present invention to change a specified timer or reset the timer to the RFI defined durations.

ModifyTnTimerList(timerToSet, scanlntvlInSecs, timeLenInSecs)

Where timerToSet is a value between 6 and 10, scanlntvlInSecs determines how often the timer list should be scanned (e.g., checked for expirations), and timerLenInSecs determines how long the Timer should run for.

ReSetTnTimerList(timerToReSet)

Where timerToReSet is a value between 6 and 10 ReSetTnTimerList resets the timer to the RFI defined default durations.

Trace Log

One embodiment of the present invention also includes a trace log facility to display the contents of messages received and transmitted to/from the CMTS as well as the status of various internal functions (e.g., Dynamic Service Flow and Transaction FSMs). The commands below may be used to set the following trace log and start the basmonitor to view the status of DSX Messages on the CMTS.

slot<chassis>/<slot>

trace-log cmts-12 info

basmonitor

Programmable Responses

To support the ATP and Negative Testing of CMs, the following modes of programmable response are defined for Dynamic Service Messages. These may be implemented as a one-shot response, that is, once the programmed response is sent/processed, the programmed response is disabled (e.g., to prevent subsequent processing to use this value).

SYNTAX

->SetDsxProgRsp<“value”>

Usage:

setDsxProgRsp(<[“0”-“19”]>)

[Values should be quoted]

where,

0=Programmed DSX Response Disabled

1=Programmed DSX Response Enabled

2=Respond to DSX Response w/ DSC-REQ

3=Respond to DSX Response w/ DSX-RSP

4=Respond to DSX Request w/ DSC-REQ

5=Respond to DSX Request w/ DSX-REQ

6=Respond to DSX Request w/ DSX-ACK

7=Respond to DSX Ack w/ DSX-REQ

8=Respond to DSX Ack w/ DSX-ACK

9=Respond to DSX w/ DSD-REQ

ATP Related Values

The first, second, third and ninth options in the programmable response list, above, are directly applicable to tests defined in the DOCSIS ATP.

All remaining options in the programmable response list, above, can be combined with other programmable settings to negative test a CM or the CMTS. Additional unexpected responses can be defined and are possible using different settings. For example, responding to an acknowledgment with a response may be the same as skipping or ignoring the acknowledgment. Similarly, responding to a response with a request is the same as skipping or ignoring the response. Other similar tests are likewise within the scope of the present invention.

### Conclusion

A method and apparatus for testing one or more cable modems or CMTS devices in a cable modem system has been disclosed. Although specific embodiments have been illustrated and described herein, it will be appreciated by those of ordinary skill in the art that any arrangement that is calculated to achieve the same purpose may be substituted for the specific embodiments shown. This application is intended to cover any adaptations or variations of the present invention. Therefore, it is intended that this invention be limited only by the claims and the equivalents thereof.

What is claimed is:

1. A method of testing one or more devices of a cable modem system, comprising:
specifying a MAC address for at least one device under test;
specifying one or more test messages for the at least one device under test;
specifying a mode of failure for the test messages;
sending the one or more test messages according to the mode of failure; and
determining whether one or more devices of the cable modem system respond appropriately.

2. The method of claim 1 further comprising specifying a change in value to standard timer.

3. The method of claim 1 wherein the message comprises a MAC Management Message.

4. The method of claim 1 wherein the message comprises a registration message.

5. The method of claim 1 wherein the message comprises a bandwidth request.

6. The method of claim 3 wherein the MAC Management Message comprises one or more Dynamic Service messages.

7. The method of claim 1 wherein the message comprises a registration message.

8. The method of claim 1 wherein the message comprises a bandwidth request.

9. The method of claim 1 wherein the mode of failure comprises skipping a message.

10. The method of claim 1 wherein the mode of failure comprises providing one or more messages outside the timing requirements specified by a standard.

11. The method of claim 1 wherein the test messages comprise flow control messages.

12. The method of claim 3 wherein the mode of failure is negative.

13. The method of claim 3 wherein the test comprises a negative test.

14. The method of claim 1 wherein the test may be performed on a plurality of devices under test at the same time.

15. The method of claim 1 wherein the devices under test comprise a cable modem.

16. The method of claim 1 wherein the devices under test comprise a cable modem termination system.

17. The method of claim 1 wherein the test includes modifying one or more timers associated with dynamic service messaging.

18. A method of testing one or more components of a cable modem system, the method comprising:
specifying one or more devices to test by a MAC number;
redefining a timer associated with a MAC management messaging state machine; and
measuring the response of the one or more devices under test to determine if there has been an anomaly.

19. The method of claim 18 wherein the MAC management message comprises a dynamic service message.

20. A method of testing one or more components of a cable modem system, the method comprising:
specifying one or more devices to test by MAC number;
transmitting one or more arbitrary messages to the device under test in response to received messages;
determining the response of the device under test.

21. The method of claim 20 wherein the messages comprise dynamic service messages.

22. The method of claim 20 wherein the messages comprise MAC management messages.

23. A method of testing one or more components of a cable modem system, the method comprising:
skipping one or more MAC Management Messages defined for one or more cable modems;
determining the response of the one or more cable modems for which the one or more MAC Management Messages was skipped.

24. The method of claim 23 further comprising determining the response of a cable modem termination system.

25. The method of claim 23 further comprising logging the responses.

26. The method of claim 23 further comprising identifying errors in the responses.

27. A system for testing one or more components of a cable modem system, comprising:
an interface to a cable modem system;
application software to monitor, read and write cable modem attributes and parameters via the interface;
agent software to receive cable modem and cable modem termination system messages from the interface and to respond to the messages; and
collection software to collect network objects or data variables that represent attributes of the managed agent.

28. The system of claim 27 further comprising a management information base.

29. The system of claim 27 wherein the agent software may be programmed to skip one or more messages.

30. The system of claim 27 wherein the agent software may be programmed to respond inappropriately to one or more messages.

31. A system for testing one or more components of a cable modem system, comprising:
an interface to a cable modem system wherein;
application software to monitor, read and write cable modem attributes and parameters via the interface;
agent software to receive cable modem and cable modem termination system messages from the interface and to respond to the messages wherein the agent software may be programmed to respond inappropriately to the messages; and
collection software to collect network objects or data variables that represent attributes of the managed agent.
